(19) United States
(12) Patent Application Publication
(10) Pub. No.: US 2016/0125674 A1
(43) Pub. Date: May 5, 2016

(54) METHOD AND SYSTEM FOR MANAGING A MOBILE EQUIPMENT FLEET

(71) Applicant: SYNCRUDE CANADA LTD. in trust for the owners of the Syncrude Project, as such owners exist now and, Fort McMurray (CA)

(72) Inventors: PAUL WOHLGEMUTH, Fort McMurray (CA); ED BLANCHE, Devon (CA); IAN PARSONS, Edmonton (CA); PETER READ, Fort McMurray (CA); KYLE GOGOLINSKI, Fort McMurray (CA); MICHELLE NOER, Fort McMurray (CA); DAVID GREENWOOD, Fort McMurray (CA)

(21) Appl. No.: 14/931,677

(22) Filed: Nov. 3, 2015

Related U.S. Application Data
(60) Provisional application No. 62/075,033, filed on Nov. 4, 2014.

(51) Int. Cl. G07C 5/08; H04L 12/26; G07C 5/00; H04L 12/24

(52) U.S. Cl. CPC G07C 5/08; H04L 41/0631; H04L 43/06; G07C 5/008

(57) ABSTRACT

A computer-implemented method and a system for managing signals generated by onboard systems of a mobile equipment fleet, where each of the signals contain operating condition information associated with one of the items of the fleet. The system continuously receives the signals as transmitted by the onboard systems via a communications network. For each of the received signals, the system selects a rule from a rules database based on the equipment operating condition information in the received signal. The rule contains a cause and an action associated with an equipment operating condition. The system generates a report that includes the equipment operating condition, the cause and the action of the selected rule and transmits it to an operator device via the communications network.

### CROSS REFERENCE TO RELATED APPLICATIONS

The present application claims priority from U.S. application Ser. No. 62/075,033, filed Nov. 4, 2014, which is incorporated by reference herein in its entirety.

### FIELD OF THE INVENTION

The present invention relates to mobile equipment, and more particularly to a method and a system for managing alarm signals generated by onboard systems of mobile equipment.

### BACKGROUND OF THE INVENTION

Mobile mining equipment used in open-pit mining, such as wheeled haul trucks and tracked equipment (such as excavators, graders, dozers, loaders, shovels, spreaders, conveyors, and the like) may be equipped with computerized onboard systems that monitor various systems of the equipment and generate alarms in response to equipment faults. A wireless local area network (LAN) may be used to transmit alarm signals from the equipment in the mine to a remotely located server. As mobile mining equipment fleets can include hundreds of items, each of which can potentially generate many types of alarms, there is a need for a method and system to rationally manage the alarms.

### SUMMARY OF THE INVENTION

The present invention is directed to a computer-implemented method and a computer-based system that can be used to provide a structured process for managing a mobile equipment fleet.

Thus, in one aspect, the present invention provides a computer-implemented method for managing a plurality of signals generated by onboard systems of a mobile equipment fleet, wherein each of the signals comprises equipment operating condition information associated with one of the mobile equipment items of the fleet, the method comprising the steps of:
(a) storing in the memory a rules database comprising a plurality of rules, wherein each rule comprises a cause and an action associated with an equipment operating condition;
(b) continuously monitoring for and receiving the signals as transmitted by the onboard systems, via a communications network;
(c) for each of the received signals, taking a response step comprising the steps of:
   (i) selecting one of the rules based on the equipment operating condition information in the received signal; and
   (ii) generating a report comprising the equipment operating condition, the cause, or the action of the selected rule.

In one embodiment of the method, the response step further comprises transmitting the generated report to an operator device via the communications network.

In embodiments of the method, the step of selecting one of the rules may be based on: matching the equipment operating condition information in the received signal to the equipment operating condition of one of the rules; calculating an equipment operating condition trend using the equipment operating condition information of the received signal; comparing the equipment operating condition information in the received signal to equipment operating condition information for a different one of the mobile equipment items; or usage information for the mobile equipment item associated with the equipment operating condition information of the received signal.

In another aspect, the present invention provides a system for managing a plurality of signals generated by onboard systems of a mobile equipment fleet, wherein each of the signals comprises equipment operating condition information associated with one of the mobile equipment items of the fleet. The system comprises a processor, a communication means for the processor to receive and transmit information via a communications network, and a memory storing a set of instructions executable by the processor to implement a method as described above.

In yet another aspect, the present invention provides a computer program product comprising a medium storing instructions readable by a processor to cause the processor to execute a method as described above.

Other features will become apparent from the following detailed description. It should be understood, however, that the detailed description and the specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the following figures. It is understood that the drawings provided herein are for illustration purposes only and are not necessarily drawn to scale.

FIG. 1 is a schematic depiction of one embodiment of the system of the present invention in communication via a communications network with a mobile mining equipment fleet and a plurality of operator devices.

FIG. 2 is a functional block diagram of one embodiment of the system of the present invention.

FIG. 3 is a graphical user interface showing an example of a fault-cause-action rule of the rules database used in one embodiment of the present invention,

FIG. 4 is a schematic representation of a prioritization scheme used in one embodiment of the present invention.

FIG. 5 is a graphical user interface summarizing reports generated by one embodiment of the system of the present invention.

FIG. 6 is a graphical user interface summarizing reports generated by one embodiment of the system of the present invention.

FIG. 7 is a graphical user interface shown one report generated by one embodiment of the present invention.

FIG. 8 is a flow chart showing the work flow in the use of one embodiment of the system of the present invention,

### DESCRIPTION OF THE PREFERRED EMBODIMENT

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a computer-implemented method and a system for managing a plurality of signals generated by onboard systems of a mobile equipment fleet, wherein each of the signals comprises equipment operating condition information associated with one of the mobile equipment items of the fleet.

As used herein, “mobile equipment” means any mobile machine and includes mobile mining equipment. “Mobile mining equipment” means mobile equipment that is used in open-pit mining operations including, without limitation, wheeled and tracked machinery for exploring and develop mine sites, and removing, stockpiling, or processing overburden and ore. Mobile mining equipment includes, without limitation, haul trucks, excavators, graders, dozers, loaders, shovels, spreaders, conveyors, and the like.

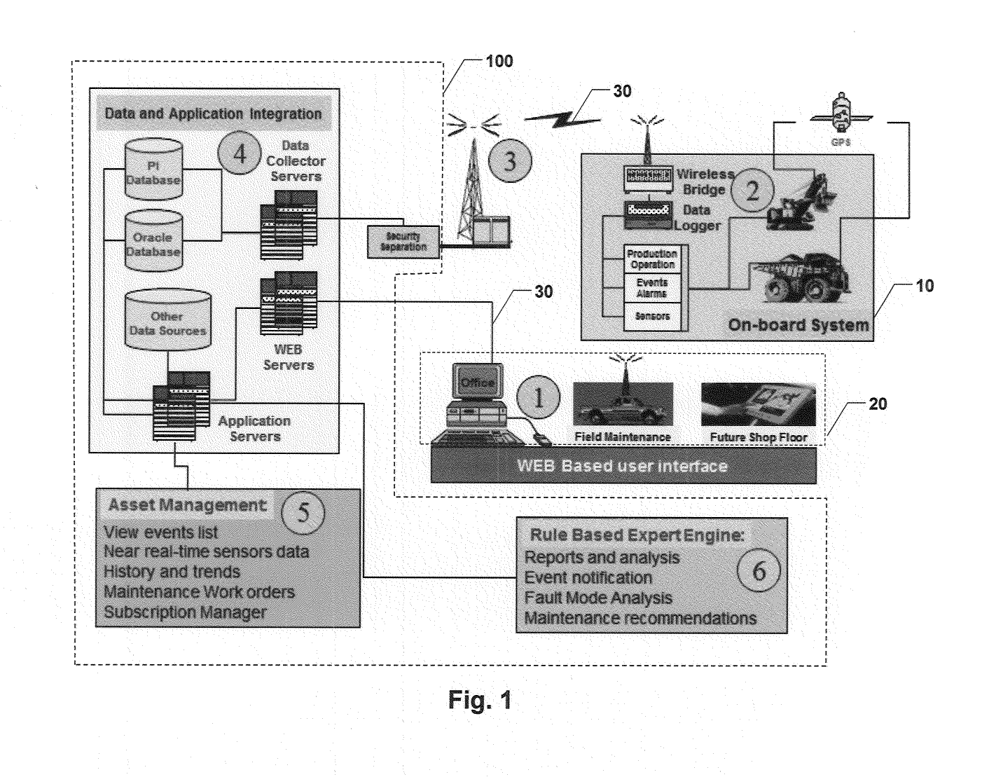

FIG. 1 shows a mobile equipment fleet, generally denoted 10, and a plurality of operator devices, generally denoted 20, in communication via a communications network 30 with one embodiment of the system 100 of the present invention. In the embodiment shown in FIG. 1, the mobile equipment fleet 10 is a mobile mining equipment fleet that includes a haul truck and an excavator. It will be appreciated that the types and numbers of mobile equipment items are merely illustrative and not limiting of the present invention.

Each mobile equipment item of the mobile equipment fleet 10 is equipped with a computerized onboard system that monitors equipment operating condition information generated by one or more sensors associated with various subsystems of the mobile equipment item or the electronic control module (ECM) of the mobile equipment item. Non-limiting examples of the subsystems that may be monitored include drive train systems, suspension systems, electrical systems, and hydraulic systems. Non-limiting examples of the types of operating condition information monitored by onboard systems include fluid temperature, pressure, and levels, component movements and stresses, payload, operating time, equipment speed, equipment position (e.g., as determined through a global positioning system (GPS)). Such onboard systems are known in the art and commercially available from manufacturers of mobile equipment. Alternatively, the onboard system may be specifically adapted to monitor equipment operating conditions of interest to a particular operator.

The onboard systems may store the equipment operating condition information and compare it to a pre-determined threshold values. If the operating condition exceeds the pre-determined threshold value, the onboard system may generate and transmit a signal (such as an alarm signal) containing the equipment operating condition information via the communications network 30. The equipment operating information in the transmitted signal may be quantitative, qualitative, or both quantitative and qualitative in nature.

The operator devices 20 are computer devices that allow operators to receive or retrieve electronic reports (as described below) that are generated by the system 100 and display them in a human readable form. Non-limiting examples of suitable operator devices 20 include a general purpose computer such as a desktop computer, a portable laptop computer, a tablet computer, or smart phone. The operator devices 20 may be located remotely from the mobile equipment fleet 10 and the system 100, such as in an office environment or vehicle used either by a member of a technical troubleshooting personnel (e.g., a service writer, field mechanic, mobile engineer) or of an operations community (e.g., a manager responsible for the operation of the mobile equipment fleet).

The communications network 30 permits transmission of signals between the system 100 and the mobile equipment fleet 10, and between the system 100 and the operator devices 20. The communications network 30 may comprise wired and wireless communications means, including the Internet, an intranet, a wide area network, a local area network (LAN), a public switched telephone network, a cellular telephone network, a satellite link system, or a combination of the foregoing. It will therefore be understood that the onboard systems of the mobile equipment fleet 10, the operator devices 20 and the system 100 comprise suitable communication means known in the art (e.g., modems and RF transceivers) adapted for use with the communications network 30.

In industrial application, the mobile equipment fleet 10 may include several hundred mobile equipment items, each having an onboard system monitoring thousands of sensors. Extended operation of the mobile equipment fleet has the potential to generate such a large number of signals that a computer is practically required to manage the signals.

Thus, in one aspect, the system 100 comprises a computer that manages a plurality of alarm signals generated by a plurality of mobile equipment items. In general, the computer comprises a processor and a memory storing a set of instructions which are executed by the processor to manage the signals as will be described below. The computer may be a general purpose computer specifically adapted with the stored set of instructions, a special purpose computer, a microcomputer, an integrated circuit, a programmable logic device or any other type of computing technology known in the art that is capable of performing the method of the present invention. The memory may comprise any medium capable of storing instructions readable by a processor. The computer may comprise a single unitary device or a plurality of physically discrete components operatively connected together. For example, in the embodiment shown in FIG. 1, the computer comprises a secured data collector server for receiving alarm signals and storing them in databases, an application server that operates on the alarm signals stored in the databases in accordance with a rules engine and asset management engine to generate reports, and a web server that transmits reports generated by the application server to the operator devices 20.

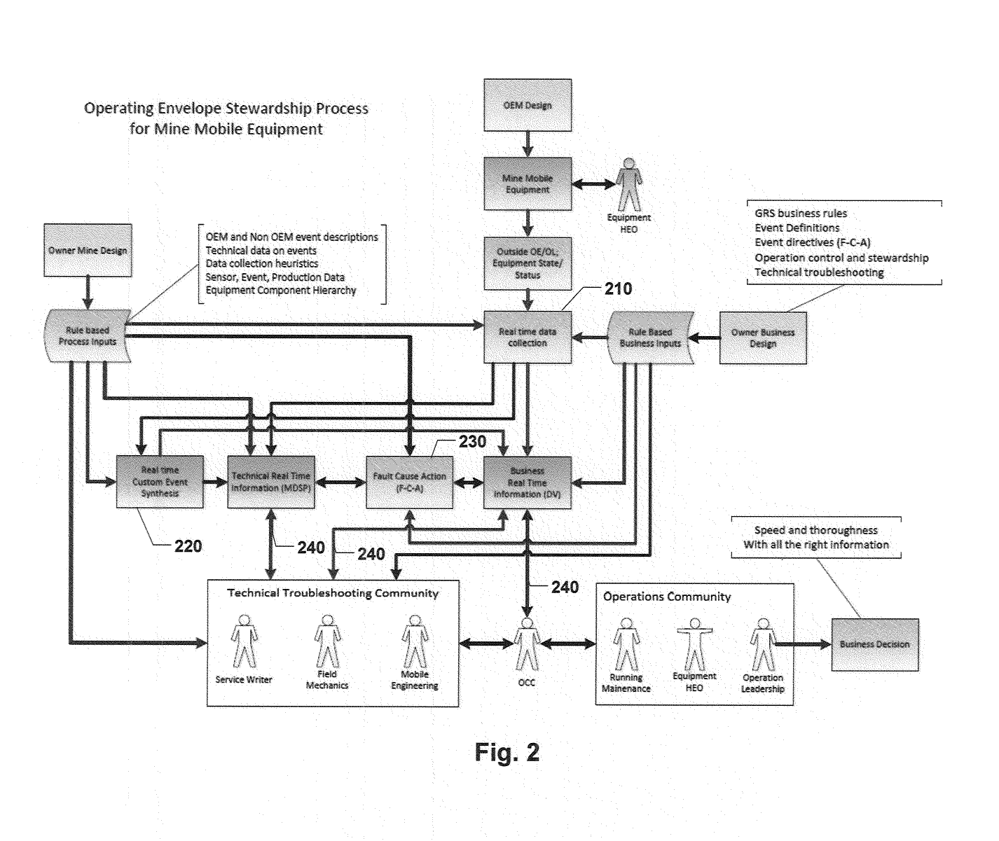

The use and operation of one embodiment of the system 100 is now described with reference to the remaining Figures. Referring first to FIG. 2, in this embodiment, the system 100 is designed to receive a number of signals which are generated by on-board systems that are present on each of the pieces of equipment of the mobile equipment fleet. Generally, these on-board systems are provided by the original equipment manufacturers (OEM design) but it is understood that other signal generating systems can also be included, for example, by adding a global positioning system or GPS. Hence, the first step (step 210) involves collecting the equipment specific data, which is referred to herein as real time data collection.

In one embodiment, the real time data (also referred to herein as “signal data”) may then be subjected to real time custom event synthesis (step 220). Real time custom event synthesis 220 involves the use of a set of mathematical analysis use cases (in a mathematical analysis module), which provides a framework to apply mathematical rules to signal data and raise alarms when the signal data goes outside of specified limits. Hence, mathematical rules are applied to signal data corning from mobile mining equipment and alarms are raised when issues of concern are detected. These alarms are fully integrated with similar messages that are generated from the on-board systems and the response is monitored through the operator care DV panel (step 240).

There are some unique features required when applying real time custom event synthesis to mobile equipment. First, the signal data must be received onto the LAN and stored in the sensor databases. This wireless data collection causes the first challenge in that the data can be delayed by wireless connectivity. The second challenge is that mine mobile equipment does not run in steady state. Mine equipment is highly dynamic, running from zero ground speed to full speed on a regular basis. Dealing with data delays, data gaps, and filtering for common operating circumstances are unique features that need to be built in to step 220 to enable condition monitoring. Thus, step 220 involves looking for specific operating conditions and evaluating the signal data for only that operating condition over time to determine the existence of failure progression. An event is created into the alarm database when a failure progression or operating bad practice is detected. It is understood, however, that step 220 is optional.

Examples of unique mathematical models which can be added to real time custom event synthesis that may be specific for monitoring truck and shovel fleets are as follows. In one example, operator dumping practice looks at how the payload is dumped to ensure that operators raise the body as fast as possible. Dumping as fast as possible is proven to control jarring events when dumping rich oil sand, which is having a positive effect on haul truck operator wellbeing.

In another example, cycle analysis is applied to a number of items, such as lubrication injection, and hydraulic pump performance. This analysis is commonly focused on times when the truck is idling with no operator influence. This analysis can be applied to any equipment function that is on-off. It can monitor the condition that switches the function on and off, as well as the frequency at which the function is turned on and off. This is proven to be valuable in monitoring system configuration and tuning that controls equipment duty cycles and lubrication injection volumes and frequencies. Having this type of equipment function well tuned helps optimize equipment cost and performance.

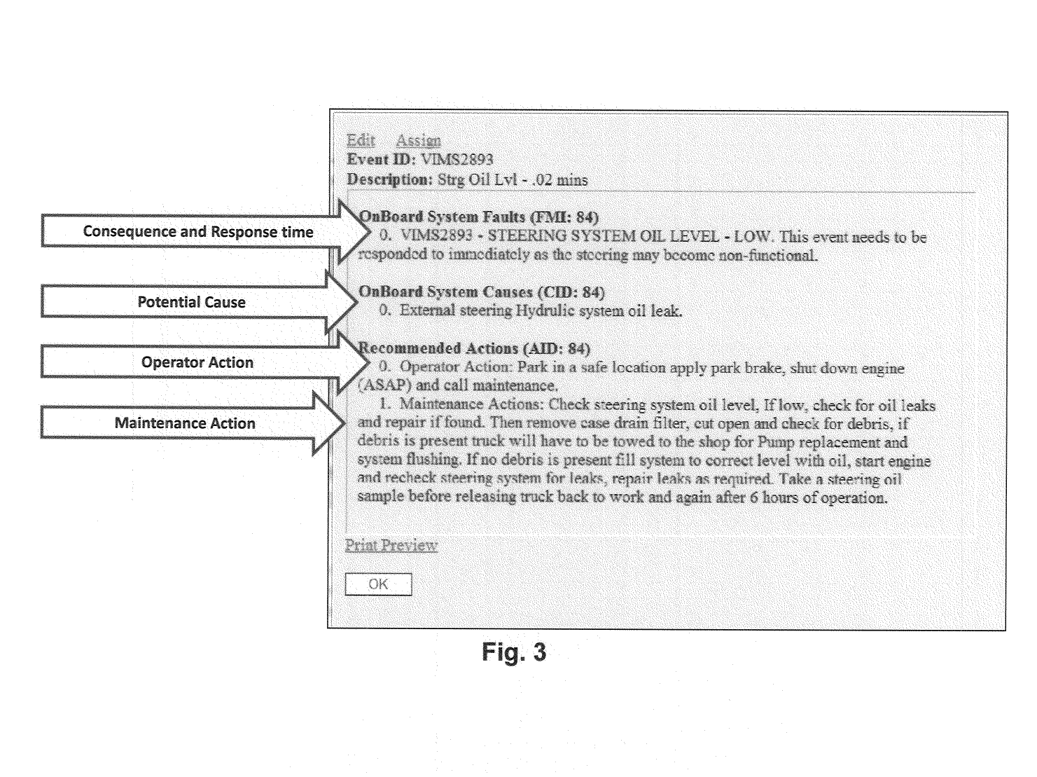

The next step in the use and operation of the system 100 involves creating a rules database which is stored in the memory (step 230). The rules database provides a catalogue of “fault-cause-action” rules. The “fault” component of each rule corresponds to a potential equipment operating condition for a mobile equipment item. The “cause” component of each rule corresponds to a suggested reason for the equipment operating condition. The “action” component of each rule corresponds to a recommended operational or maintenance response to the equipment operating condition. It will be understood that the “cause” and “action” components of each rule may be pre-determined by technical troubleshooting personnel and an operations community having regard to a myriad of business factors (shown as “owner business design”) such as risk assessment and management, and operational factors (shown as “owner mine design”) such as the mobile equipment item, and the onboard system. By way of a non-limiting example, FIG. 3 shows a graphical user interface displaying one embodiment of a fault-cause-action rule relating to a haul truck. In this example, the “fault” is a low steering system oil level, the suggested “cause” is an external steering hydraulic system oil leak, and the recommended “action” includes an operator action to park the haul truck, and a maintenance action to inspect and repair the steering system in accordance with a specified procedure.

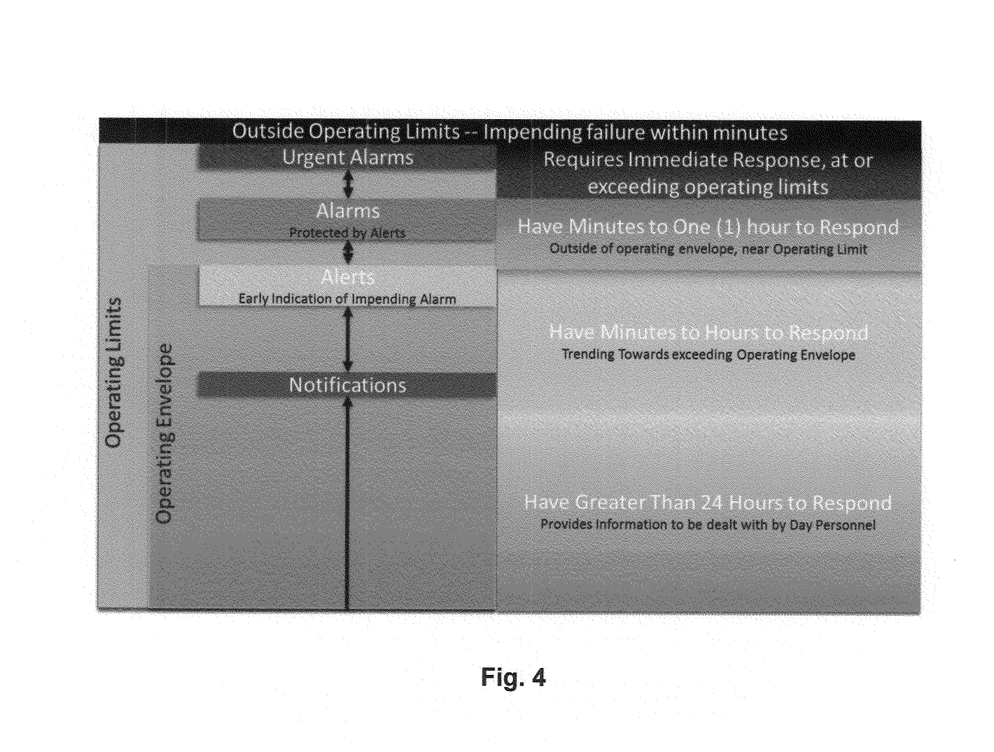

In one embodiment, the equipment operating condition of each rule is further associated with a priority indicator reflecting the seriousness of an equipment fault notification. For example, the priority indicator may be a value between 1 and 3, with larger values indicative of higher priority. The priority indicator may be associated with a response time for the recommended action. For example, in one embodiment of a prioritization scheme for equipment operating conditions as shown in FIG. 4, the least serious equipment operating conditions (described as “Notifications”) require a response time of greater than 24 hours, whereas the most serious equipment operating conditions (shown as “Urgent Alarms”) require an immediate response. The priority indicator of each rule may also be pre-determined by technical troubleshooting personnel and an operations community.

With the rules database initialized, the system 100 continuously monitors for and receives signals generated by the onboard systems. In response to receiving a signal, the system 100 selects one of the rules based on the equipment operating condition information contained in the alarm signal, and in accordance with criteria in the rules database. In one embodiment, this rule selection process is based on matching the equipment operating condition information in the received signal to the equipment operating condition of one of the rules.

In other embodiments, this rule selection process can involve the system further analyzing the equipment operating condition information in the received signal for a more nuanced selection of the rule. This may be of particular importance where the onboard system is not adapted to detect a particular fault of interest to the operator, or where a particular equipment operating condition may be associated with multiple causes and actions. Alternatively, the rule selection process may be based on additional information either provided in the received signal or a different signal generated by the onboard system, either autonomously or in response to a query by the system 100, or in information that is otherwise received and stored in the memory of the system 100.

In one embodiment, the rule selection process is comparing the equipment operating condition information to a pre-defined envelope. If the information is outside the envelope, then the information is associated with a particular fault in the rules database.

In one embodiment, the rule selection process is based on an equipment operating condition trend calculated using the equipment operating condition information of the received signal. For example, where the equipment operating condition information concerns a low oil level in the steering system, a calculated trend in the level of oil remaining over time may be used to determine a rate of oil loss. The rate of oil level loss may indicate the preferential selection of one cause (e.g., a crack in an oil reservoir) over another (e.g. debris in an oil reservoir). Also, the system may preferentially select one action and priority indicator (e.g., repairing a cracked reservoir, with a higher priority) over another (e.g. inspecting a reservoir for debris, with a lower priority).

In one embodiment, the rule selection process is based on a comparison of the equipment operating condition information in the received signal to equipment operating condition information for a different one of the mobile equipment items. For example, where the equipment operating condition information concerns a low oil level in the steering system, the system may determine whether it has received signals from similar mobile equipment items in the fleet indicative of low oil levels. If it has, the system may preferentially select a rule indicative of a systemic cause for the low oil level (e.g., a need for maintenance of the steering component) over a cause that is particular to the mobile equipment item (e.g., a crack in an oil reservoir).

In one embodiment, the rule selection process is further based on usage information that is extrinsic to the mobile equipment item, but associated with the equipment operating condition information of the received signal. For example, where the equipment operating condition information concerns a high suspension component stress, the usage information may be a ground surface condition. If the usage information indicates a hard ground condition, the system may preferentially select one action (e.g., allowing for a higher speed of the mobile equipment), over another (e.g. allowing for a lower speed of the mobile equipment) for a soft ground condition.

It will be understood that more than one of the rules selection processes as described above may be combined with each other.

Once the system 100 has selected a rule from the rules database, the system 100 generates one or more reports, and transmits the reports to one or more operator devices (step 240) via the communications network 30. Each report includes the equipment operating condition, the cause, and the action of the selected rule. Other reports containing more or less information may be generated depending on the intended user of the operating device.

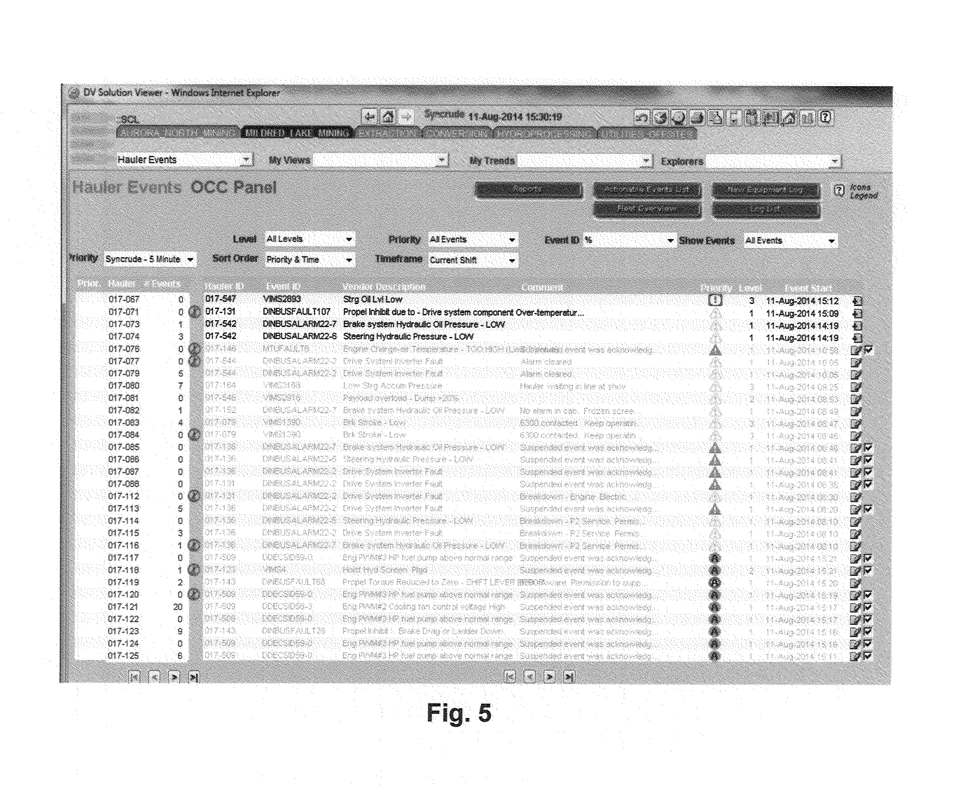

In one embodiment, for example, the generated report is displayed on an operator device 20 used by an operator care champion (OCC) responsible for overseeing the actions of the technical troubleshooting community and the operations community. The generated report is displayed on a graphical user interface (described as an “OCC Panel”). As shown in one embodiment in FIG. 5, the OCC Panel summarizes each of the generated reports and presents them in a tabular form, with column fields for the equipment identifier, an event ID (an alpha-numeric identifier generated by the onboard system), the equipment operating condition information provided in the signal generated by the onboard system, the priority indicator, and the time of the received signal. The summary table may be sorted by any of the column fields.

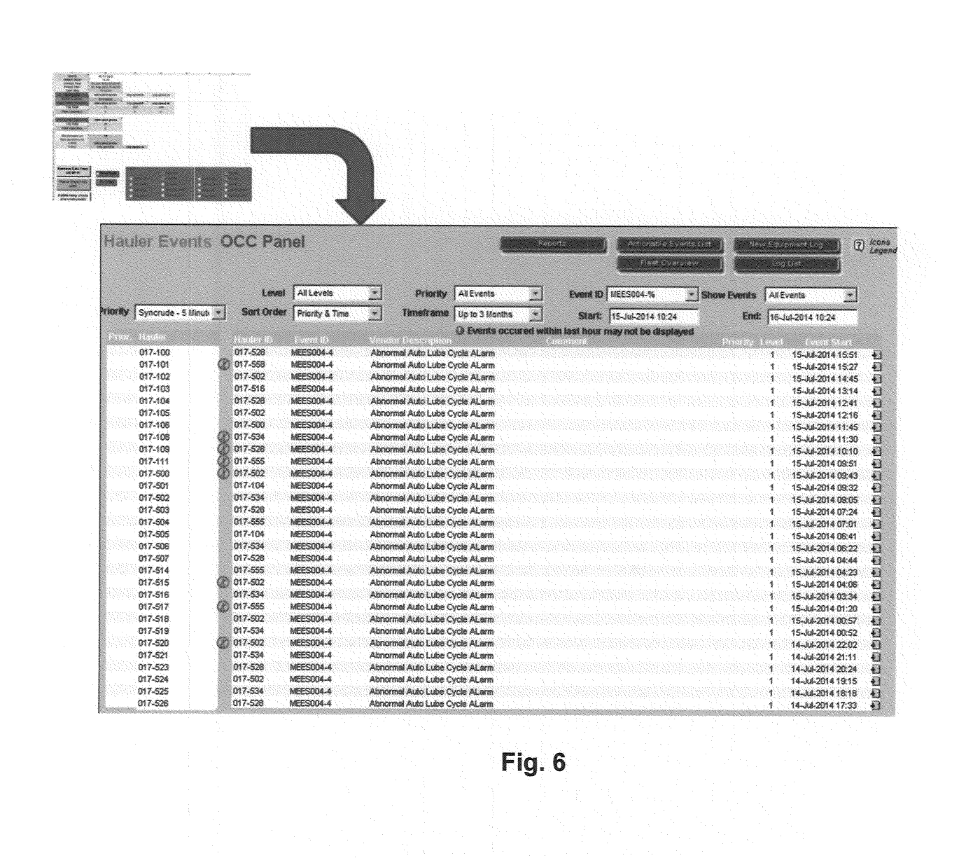

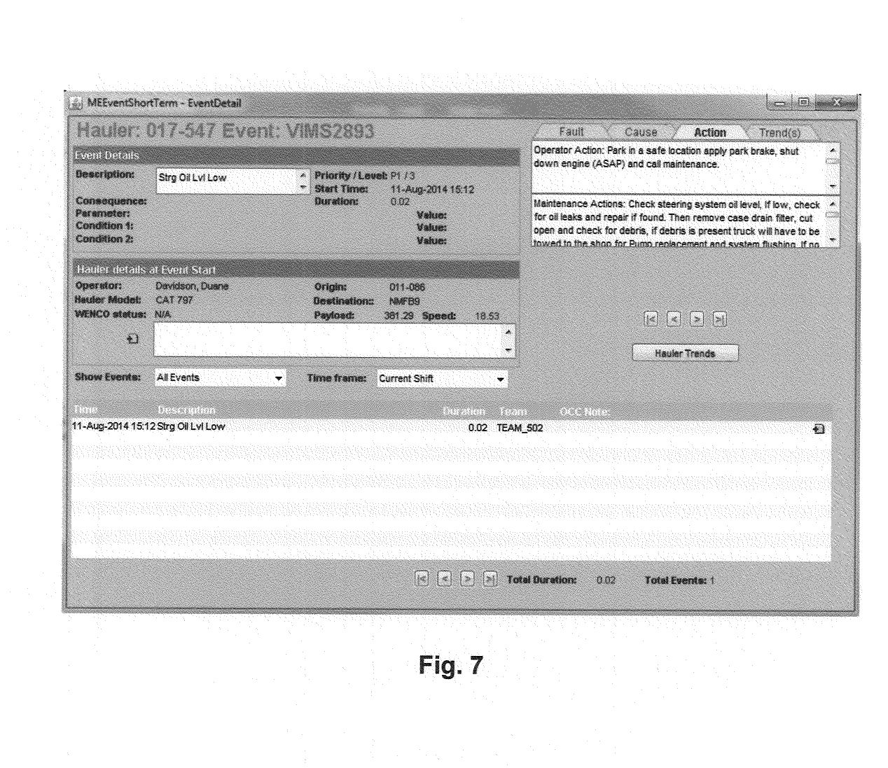

FIG. 6 illustrates an embodiment where real time custom event synthesis (step 220) is used. In this embodiment, the user of the OCC Panel may also filter the reports by equipment operating condition information. As an example, in FIG. 6, the OCC Panel summarizes reports for signals from different mobile equipment items related to an “Abnormal Auto Lube Cycle Alarm”. These reports may be filtered for equipment operating conditions such as minimum lubrication pressure and a minimum engine speed. This type of analysis may be used to evaluate the appropriateness of the rule selected by the system, and support additional decision making. Using the OCC Panel, the OCC can access the individual generated reports by clicking on the report. As shown in one example in FIG. 7, the report contains fields for the fault, cause and action components of the selected rule, trending information, and the time of the fault.

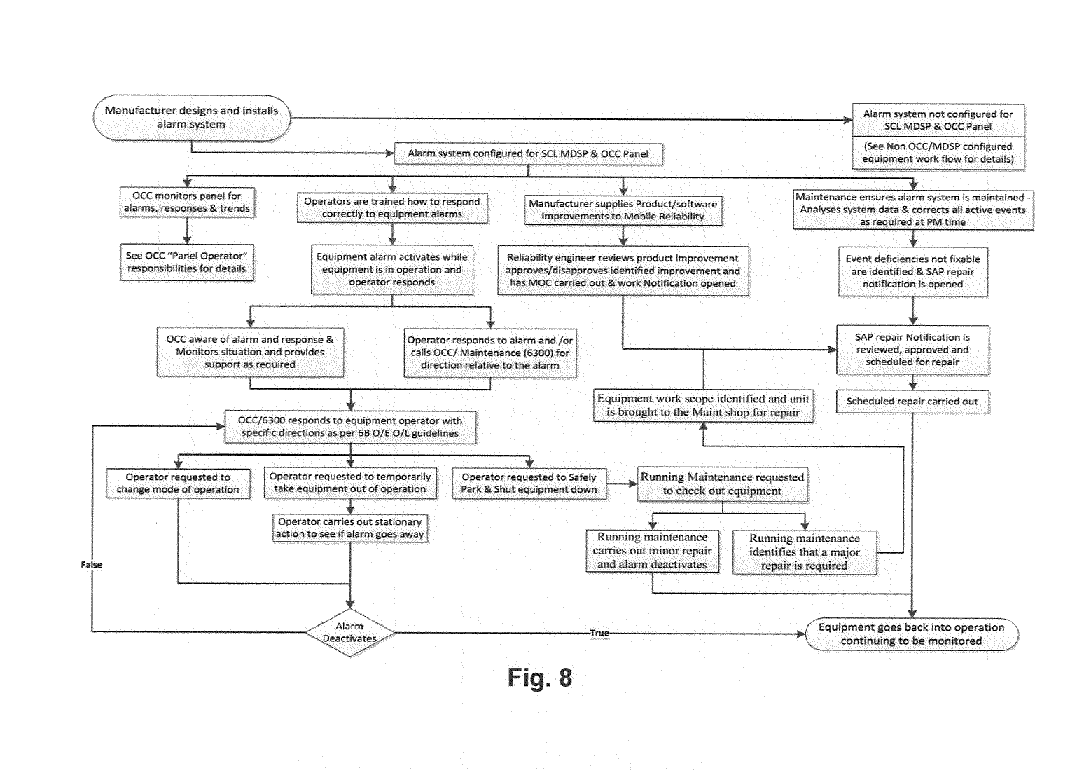

FIG. 8 shows one embodiment of the workflow resulting from the OCC receiving the generated report at an OCC panel. It will be understood that the various requests, responses, and other communications shown in FIG. 5 between the OCC, and the operators may be automatically generated by the system 100 and communicated to other operator devices 20 via the communications network 30, such as through a Internet web portal. Once an alarm signal has been addressed by taking the action, the operator may use an operator device 20 to transmit a notification to the system 100 to modify the generated report to indicate that the alarm is deactivated. The system 100 receives such a notification and updates the generated report accordingly.

Fleet operators may use the method and system as described above to help them enhance the fleet's productivity, control maintenance costs, and manage safety risks. For example, the system may be used for supporting maintenance decision, and scheduling maintenance activities for mobile equipment items.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A computer-implemented method for managing a plurality of signals generated by onboard systems of a mobile equipment fleet, wherein each of the signals comprises equipment operating condition information associated with one of the mobile equipment items of the fleet, the method comprising the steps of:
(a) storing in the memory a rules database comprising a plurality of rules, wherein each rule comprises a cause and an action associated with an equipment operating condition;
(b) continuously monitoring for and receiving the signals as transmitted by the onboard systems, via a communications network;
(c) for each of the received signals, taking a response step comprising the steps of:
(i) selecting one of the rules based on the equipment operating condition information in the received signal; and
(ii) generating a report comprising the equipment operating condition, the cause, or the action of the selected rule.

2. The method of claim 1 wherein the response step further comprises transmitting the generated report to an operator device via the communications network.

3. The method of claim 1 wherein the step of selecting one of the rules is based on matching the equipment operating condition information in the received signal to the equipment operating condition of one of the rules.

4. The method of claim 1 wherein the step of selecting one of the rules is based on comparing the equipment operating condition information of the received signal to a pre-defined envelope stored in the rules database.

5. The method of claim 1 wherein the step of selecting one of the rules is based on an equipment operating condition trend calculated using the equipment operating condition information of the received signal.

6. The method of claim 1 wherein the step of selecting one of the rules is based on a comparison of the equipment operating condition information in the received signal to equipment operating condition information for a different one of the mobile equipment items.

7. The method of claim 1 wherein the step of selecting one of the rules is further based on usage information for the mobile equipment item associated with the equipment operating condition information of the received signal.

8. A system for managing a plurality of signals generated by onboard systems of a mobile equipment fleet, wherein each of the signals comprises equipment operating condition information associated with one of the mobile equipment items of the fleet, the system comprising:
(a) a processor;
(b) a communication means for the processor to receive and transmit information via a communications network; and
(c) a memory storing a set of instructions executable by the processor to implement a method as claimed in claim 1.

9. A computer program product comprising a medium storing instructions readable by a processor to cause the processor to execute a method as claimed in claim 1.
